(19) United States
(12) Patent Application Publication
(10) Pub. No.: US 2006/0093329 A1
(43) Pub. Date: May 4, 2006

(54) Information record/playback apparatus

(75) Inventor: Yoshikazu Fujita, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD.

(21) Appl. No.: 11/265,508

(22) Filed: Nov. 3, 2005

(30) Foreign Application Priority Data
Nov. 4, 2004 (JP) P2004-320921

(51) Int. Cl. H04N 5/781

(52) U.S. Cl. 386/95; 386/125

(57) ABSTRACT

When instructed by an input part 18 to perform CM skip, which is to skip CMs during a playback, based on mode change recording positions (addresses) recorded in a RAM 14b, a controller 14 confirms whether there is any recording position corresponding to a mode change in a 3-minute section, i.e., a normal air time of airing CMs since the recording position at which CM skip has been instructed, but when finding a recording position corresponding to a mode change, skips CMs up to this recording position. Meanwhile, when instructed for time/picture search during a playback, based on reference time point recording positions (addresses) recorded in the RAM 14b, the controller 14 skips to the closest reference time point recording position to the recording position at which time/picture search has been instructed and continues a normal playback operation.

### BACKGROUND OF THE INVENTION

1. Field of the Invention

The present invention relates to an information record/playback apparatus which digitizes a video signal and a audio signal representing a program consisting of a main program content and a commercial message, records the video signal and the audio signal on a recording medium, and plays back and outputs the video signal and the audio signal thus recorded.

2. Description of the Related Art

A user of an information record/playback apparatus which digitizes a video signal and a audio signal representing a program and records the video signal and the audio signal on a recording medium, when watching a recorded program, generally tends to fast-forward commercial messages (CMs) inserted in a main program content and watch while skipping the CMs.

Moreover, many information record/playback apparatuses featuring a CM cutting function distinguish a main program content from CMs based on a difference of modes in the event that the mode of a audio signal representing the main program content is different from the mode of a audio signal representing the CMs. To be more specific, utilizing the fact that many CMs are created in stereo mode, these apparatuses distinguish them from main program contents created in monophonic mode, and bilingual mode, etc. (See JP-A-2003-319314 for instance.) However, this method gives rise to a problem that it is not possible to distinguish a main program content and CMs from each other when the audio of the main program content is created in the stereo mode.

To solve this problem, such an information record/playback apparatus has been proposed which is equipped with a function of recording on a recording medium a CM part to be aired together with a main program content regardless of the audio mode for a broadcast and playing back while skipping the CM part based on program mode information with which the CM part detected during a playback is recognized. (See JP-A-2001-320674 for instance.)

While among currently available functions is a function of searching a record start position for a time/picture search playback, such a program signal record/playback apparatus has been proposed which is equipped with, separately from this function, a function of searching for a time breakpoint in response to a time/picture search command and playing back from the thus found breakpoint section. (See JP-A-2002-100162 for instance.)

### SUMMARY OF THE INVENTION

The picture record/playback apparatus according to JP-A-2001-320674, although capable of skipping a CM part regardless of the audio mode for a broadcast, has a problem that skipping of a CM part necessitates generation of new information, namely, program mode information, which complicates processing.

Further, although the apparatus according to JP-A-2002-100162 is capable of jumping for a time/picture search playback to the most recent time breakpoint (e.g., 12:00) such as 00 minutes or 30 minutes from a playback position at the present time (e.g., 12:10), since it is necessary according to JP-A-2002-100162 to add date information, present time information or the like to a program signal and record these on a recording medium to this end, there is a problem that the data capacity of the program signal itself increases, influencing the recording time needed to record the program signal on the recording medium.

The present invention has been made to solve these problems, and accordingly, an object of the present invention is to provide an information record/playback apparatus which can realize CM skip and time/picture search described above by an extremely simple approach.

To solve the problems above, according to an aspect of the invention, the information record/playback apparatus is an information record/playback apparatus which digitizes a video signal and a audio signal representing a program comprised of a main program content and CMs, records the video signal and the audio signal on a recording medium, and plays back and outputs the video signal and the audio signal thus recorded, the apparatus comprising: a mode detecting unit which detects mode changes of the audio signal; a mode change position storing unit which stores, during a recording operation, recording positions corresponding to mode changes of the audio signal detected by the mode detecting unit; and a playback control unit which controls a playback of program information recorded on the recording medium, wherein the playback control unit, when instructed to perform CM skip which is to skip CMs during a playback, based on the recording positions stored in the mode change position storing unit, confirms whether there is any recording position corresponding to the mode changes in a section of a predetermined period, which is a normal air time of airing CMs, since the position at which CM skip has been instructed, and when finding a recording position corresponding to the mode changes, the playback control unit performs CM skip up to this recording position, but when not finding any recording position corresponding to the mode changes in the section of the predetermined period, the playback control unit performs CM skip for a certain period of time set in advance.

According to another aspect of the invention, stored in the mode change position storing unit are recording positions upon occurrence of mode changes of the audio signal (which are to be more specific, a mode change from the stereo mode to the monophonic mode or from the monophonic mode to the stereo mode, a mode change from the stereo mode to the bilingual mode or from the bilingual mode to the stereo mode, a mode change from the monophonic mode to the bilingual mode or from the bilingual mode to the monophonic mode, etc.). That is, regardless of whether the audio signal is a audio signal representing a main program content or a audio signal representing CMs, recording positions corresponding to all change points of the audio signal are stored.

According to another aspect of the invention, A CM is aired rarely for three or more minutes. Noting this, when instructed to perform CM skip which is to skip CMs during a playback, based on the recording positions stored in the mode change position storing unit, the playback control unit confirms whether there is any recording position corresponding to the mode changes in a section of a predetermined period (which may be three minutes for instance), which is a normal air time of airing CMs, since the position at which CM skip has been instructed, and when finding a recording position corresponding to the mode changes, the playback control unit performs CM skip up to this recording position, On the contrary, when not finding any recording position corresponding to the mode changes in the section of the predetermined period (three minutes), the playback control unit performs CM skip for a preset period of time (which is usually set to thirty seconds) set in advance as customarily practiced.

Meanwhile, in the event that a CM skip mode for skipping CMs during a playback is set in advance, the playback control unit makes the mode detecting unit constantly monitor a mode change of the audio signal, and upon a mode change, based on the recording positions stored in the mode change position storing unit, the playback control unit confirms whether there is any recording position corresponding to the mode changes in a section of a predetermined period (three minutes), which is a normal air time of airing CMs, since the position at which this change has occurred, and when finding a recording position corresponding to the mode changes, the playback control unit performs CM skip up to this recording position. On the contrary, when not finding any recording position corresponding to the mode changes in the section of the predetermined period (three minutes), the playback control unit continues playing back. This makes it possible to skip the CM part while playing back the main program content without fail.

According to another aspect of the invention, the information record/playback apparatus is an information record/playback apparatus which digitizes a video signal and a audio signal representing a program comprised of a main program content and CMs, records the video signal and the audio signal on a recording medium, and plays back and outputs the video signal and the audio signal thus recorded, the apparatus comprising: a timer unit which measures the present time; a reference time point recording position storing unit which stores, during a recording operation, recording positions as they are when the present time measured by the timer unit becomes reference time points set in advance; and a playback control unit which controls a playback of program information recorded on the recording medium, wherein the playback control unit, when instructed to perform time/picture search during a playback, based on the reference time point recording positions stored in the reference time point recording position storing unit, performs time/picture search to the closest reference time point recording position to the position at which time/picture search has been instructed and continuing a normal playback operation. In this case, the reference time points are the 0 minute, 15 minutes, 30 minutes and 45 minutes, since some 15-minute programs start at 15 minutes or 45 minutes while programs usually start at the 0 minute or 30 minutes of every hour.

Therefore, in response to an instruction for time/picture search while playing back a recording position at the recording time of 11:50 for instance, the normal playback operation is continued after skipping the period of ten minutes up to the recording position corresponding to the closest reference time point to the recording position at which time/picture search has been instructed (i.e., up to the recording position at 12:00). In short, for time/picture search, a playback starts after skipping a maximum of fifteen minutes according to the present invention.

### EFFECTS OF THE INVENTION

According to the above-aspects of the invention, the information record/playback apparatus stores only recording positions corresponding to mode changes of the audio signal and therefore can skip a CM part without fail using a simple approach of comparing these to the time intervals between the recording positions with a predetermined time (three minutes) which is the normal air time of airing CMs.

According to the above-aspects of the invention, the information record/playback apparatus stores only recording positions at reference time points during recording and therefore can perform time/picture search using a simple approach of skipping back to the recording position corresponding to the most recent reference time point and starting playing back for a time/picture search operation.

### BRIEF DESCRIPTION OF THE DRAWINGS

FIG. 1 is a block diagram of the electric structure of the HD recorder 1 which is an embodiment of the information record/playback apparatus according to the present invention.

FIG. 2 is a flow chart which shows the procedure during the recording operation.

FIGS. 3A and 3B are explanatory diagrams which illustrate recording of a broadcast signal representing a program, of which the section FIG. 3A represents recording of a recording position (address) corresponding to a mode change point of a audio signal while the section FIG. 3B represents recording of a recording position (address) corresponding to a reference time point.

FIG. 4 is a flow chart which shows the procedure during CM skip 1.

FIG. 5 is a flow chart which shows the procedure during CM skip 2.

FIG. 6 is a flow chart which shows the procedure during time/picture search.

FIGS. 7A and 7B are explanatory diagrams which illustrates a playback of a broadcast signal representing a program, of which the section FIG. 7A represents CM skip while the section FIG. 7B represents time/picture search.

### DESCRIPTION OF THE PREFERRED EMBODIMENTS

Embodiments of the present invention will now be described with reference to the associated drawings.

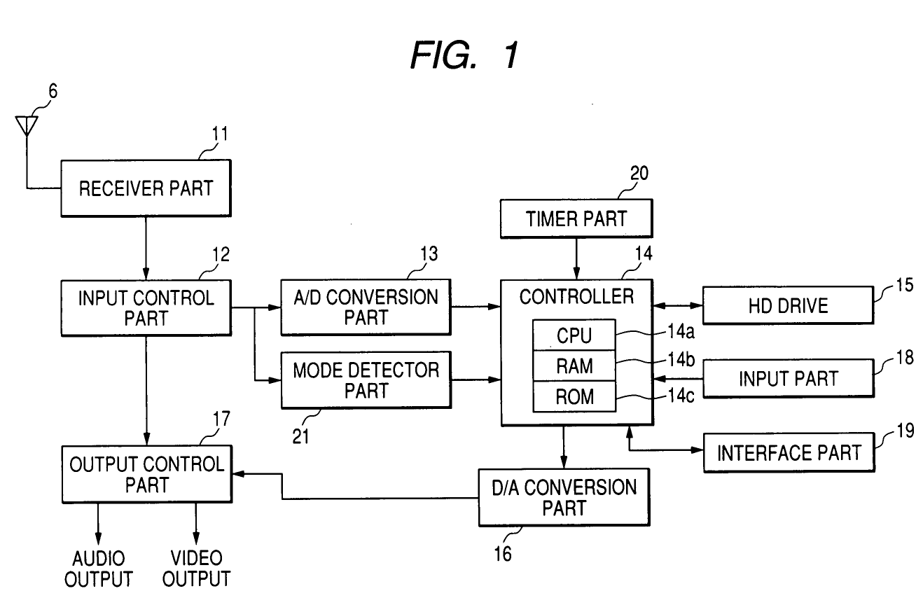

FIG. 1 is a block diagram of the electric structure of an HD recorder 1 which is an embodiment of the information record/playback apparatus. The information record/playback apparatus according to the present invention however is not limited to such an HD recorder but is applicable to digital audio visual equipment, optical disk apparatuses and the like in general, including HDD-equipped DVD recorders for instance.

The HD recorder 1 shown in FIG. 1 is comprised of a receiver part 11, an input control part 12, an A/D conversion part 13, a controller 14, an HD drive 15, a D/A conversion part 16, an output control part 17, an input part 18, an interface part 19, a timer part 20 which measures the present time, a mode detector part 21, etc.

The input part 18, comprised of switches, buttons, a remote controller and the like, is for outputting a signal corresponding to a user operation to the controller 14. This permits a user to enter various types of data to the HD recorder 1, and operate and use the HD recorder 1.

The interface part 19 is an element such as the Internet, for example, which connects an external element to the HD recorder 1 with the controller 14, and inputs to the controller 14 data acquired from an external element to the HD recorder 1.

The receiver part 11 is comprised of a tuner and a separator, etc. The receiver part 11 receives a broadcast signal representing a program via an antenna 6, and sends the broadcast signal to the input control part 12. The broadcast signal is an analog signal or a digital signal, and contains a audio signal and a video signal.

The input control part 12 extracts the audio signal and the video signal from the broadcast signal received at the receiver part 11. When the broadcast signal is an analog signal, the A/D conversion part 13 encodes (compresses) the audio signal and the video signal extracted by the input control part 12 in accordance with MPEG2 (Motion Picture Expert Group 2) and outputs the same to a controller 24. On the contrary, when the broadcast signal is a digital signal, since the audio signal and the video signal have already been MPEG2-encoded, the A/D conversion part 13 sends the audio signal and the video signal as they are to the controller 14.

The controller 14 is comprised of a CPU 14a, a RAM 14b and a ROM 14c. The controller 14 is an element which serves as a reading unit, a recognizing unit and a writing unit, and as such, reads the audio signal and the video signal from a hard disk 150 which will be described later, writes the audio signal and the video signal in the hard disk 150, recognizes a main program content and CMs of a program, and controls the respective elements forming the HD recorder 1.

The ROM 14c stores a program which is for controlling the HD recorder 1 as a whole. The CPU 14a computes for control of the respective elements forming the HD recorder 1, in accordance with the program stored in the ROM 14c, a signal from the input part 18, etc. The RAM 14b operates as a work area for the CPU 14a to compute.

The HD drive 15 is an element which together with the controller 14 forms the reading unit and the writing unit, and comprised of a hard disk (HD) which is a storage medium and a head which reads and writes information stored in the hard disk.

For playback of the audio signal and the video signal stored in the hard disk, the D/A conversion part 16 decodes (expands) these signals via the controller 14, converts them into analog signals and outputs them to the output control part 17. The output control part 17 outputs to an output apparatus, such as a television monitor, a picture tube (CRT) and a speaker, the audio signal and the video signal converted by the D/A conversion part 16.

The mode detector part 21 detects mode changes of the audio signal received at the receiver part 11 and extracted by the input control part 12 (a mode change from the stereo mode to the monophonic mode or from the monophonic mode to the stereo mode, a mode change from the stereo mode to the bilingual mode or from the bilingual mode to the stereo mode, a mode change from the monophonic mode to the bilingual mode or from the bilingual mode to the monophonic mode, etc.).

In the structure above, the broadcast signal representing the program is acquired via the antenna 6 and the receiver part 11. Further, the input control part 12 extracts the audio signal and the video signal out of the broadcast signal representing the program. The audio signal and the video signal thus extracted from the program are written and recorded in the hard disk via the A/D conversion part 13, the controller 14 and the HD drive 15.

Meanwhile, during this recording operation, the controller 14 stores recording positions (addresses) upon occurrence of mode changes of the audio signal detected by the mode detector part 21 within a predetermined area of the RAM 14b, and stores within a predetermined area of the RAM 14b recording positions (addresses) as they are when the present time measured by the timer part 20 becomes reference time points set in advance, i.e., the 0 minute, 15 minutes, 30 minutes and 45 minutes of every hour.

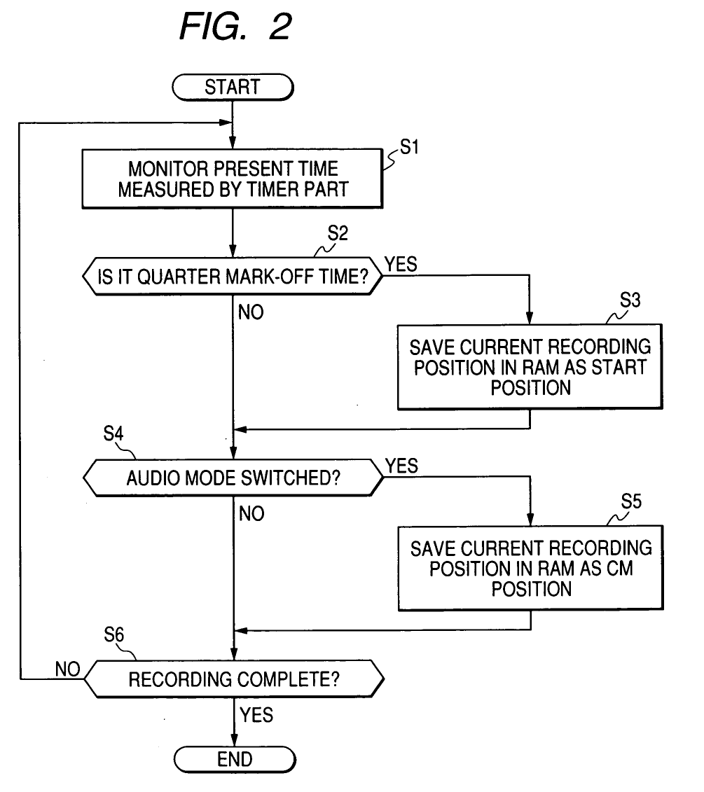

FIG. 2 shows the procedure during this recording operation.

That is, once the recording operation starts, the controller 14 constantly monitors the present time measured by the timer part 20 (Step S1), and monitors if the present time has reached the reference time point of the 0 minute, 15 minutes, 30 minutes or 45 minutes (Step S2). As the present time reaches the reference time point (Yes at Step S2), the controller 14 assumes that the recording position (address) on the hard disk at which the broadcast signal is currently being recorded is a record start position and stores (saves) this in a predetermined area of the RAM 14b (Step S3). At the same time, the controller 14 constantly monitors a detect signal from the mode detector part 21 during the recording operation (Step S4). As the mode detector part 21 detects a mode change of the audio signal and feeds the detect signal to the controller 14 (Yes at Step S4), the controller 14 based on this detect signal determines that the recording position (address) on the hard disk at which the broadcast signal is currently being recorded is a mode change position and stores (saves) this in a predetermined area of the RAM 14a (Step S5). Until the recording operation completes (Yes at Step S6), the controller 14 repeats the processing from Step S1 to Step S6.

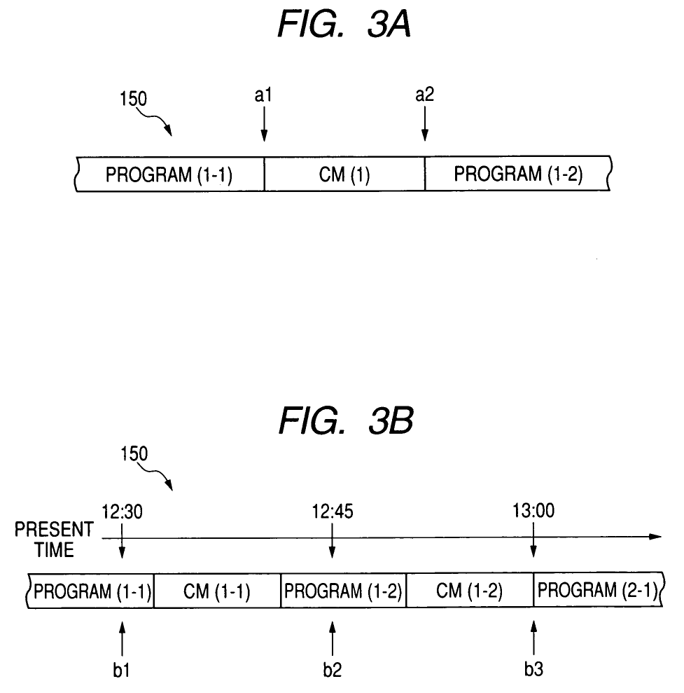

The processing from Step S1 to Step S6 will now be specifically described with reference to FIG. 3 which shows recording of a broadcast signal representing a program.

As FIG. 3A shows, during recording of a audio signal and a video signal representing a program (1) on the hard disk 150, the mode detector part 21 detects a mode change of the audio signal. In the event that a audio signal representing a program (1-1) is monophonic and a next audio signal representing a CM (1) is stereo for instance, since the audio mode switches from stereo to monophonic at the time of switching from the program (1-1) to the CM (1), the mode detector part 21 detects this mode change of the audio signal and inputs the detect signal to the controller 14. Based on this detect signal, the controller 14 determines that a recording position (address) a1 on the hard disk 150 at which the broadcast signal is currently being recorded is a mode change position and stores the same in a predetermined area of the RAM 14a. In a similar manner, since the audio mode switches from monophonic to stereo at the time of switching from the CM (1) to a program (1-2), the mode detector part 21 detects this mode change of the audio signal and inputs the detect signal to the controller 14. Based on this detect signal, the controller 14 determines that a recording position (address) a2 on the hard disk 150 at which the broadcast signal is currently being recorded is a mode change position and stores the same in a predetermined area of the RAM 14a.

Meanwhile, as FIG. 3B shows, during recording of the audio signal and the video signal representing the program on the hard disk 150, the controller 14 constantly monitors the present time measured by the timer part 20, and as the present time becomes 12:30 for instance, the controller 14 determines that a recording position (address) b1 on the hard disk 150 at which the broadcast signal is currently being recorded is a reference time point recording position and stores the same in a predetermined area of the RAM 14a. As the present time becomes 12:45 during recording of the audio signal and the video signal representing the program on the hard disk 150, the controller 14 determines that a recording position (address) b2 on the hard disk 150 at which the broadcast signal is currently being recorded is a reference time point recording position and stores the same in a predetermined area of the RAM 14a. Further, as the present time becomes 13:00 during recording of the audio signal and the video signal representing the program on the hard disk 150, the controller 14 determines that a recording position (address) b3 on the hard disk 150 at which the broadcast signal is currently being recorded is a reference time point recording position and stores the same in a predetermined area of the RAM 14a.

The program parts and the CMs are recorded one after another on the hard disk 150 in this manner, while the addresses (a1, a2, . . . ) expressing the mode change recording positions and the addresses (b1, b2, . . . ) expressing the reference time point recording positions are recorded in the RAM 14b of the controller 14.

In response to an instruction from the input part 18 for CM skip, which is to skip CMs during a playback, based on the recording positions (addresses) corresponding to the mode changes stored in the RAM 14b, the controller 14 confirms whether there is any recording position (address) corresponding to the mode changes in a 3-minute section (predetermined period), i.e., a normal air time of airing CMs since the recording position at which CM skip has been instructed, and when finding a recording position (address) corresponding to the mode changes, skips CMs up to this recording position. On the contrary, when finding no recording position (address) corresponding to the mode changes for the predetermined period of three minutes, the controller 14 performs CM skip for a preset period of time set in advance. Further, when instructed for time/picture search during a playback, the controller 14 skips CMs to the closest reference time point recording position to the recording position at which time/picture search has been instructed and continues the normal playback operation, based on the reference time point recording positions (addresses) recorded in the RAM 14b.

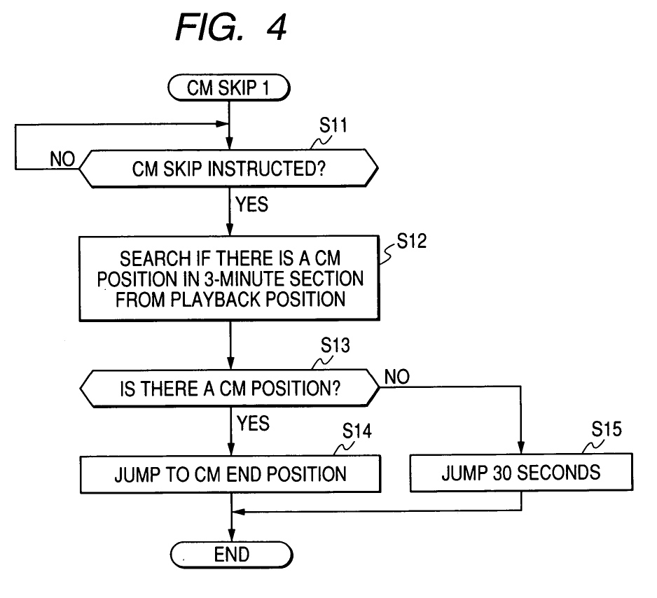

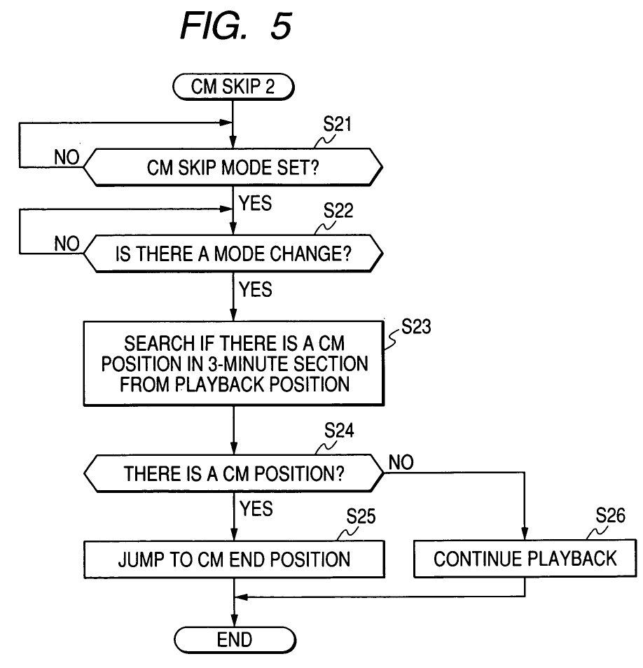

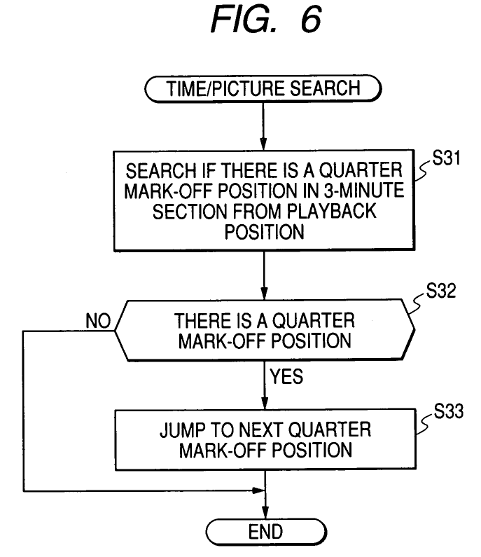

CM skip and time/picture search performed by the controller 14 will now be described in detail with reference to flow charts in FIGS. 4 through 6 and FIG. 7 which shows a playback of a broadcast signal representing a program.

<CM Skip 1>

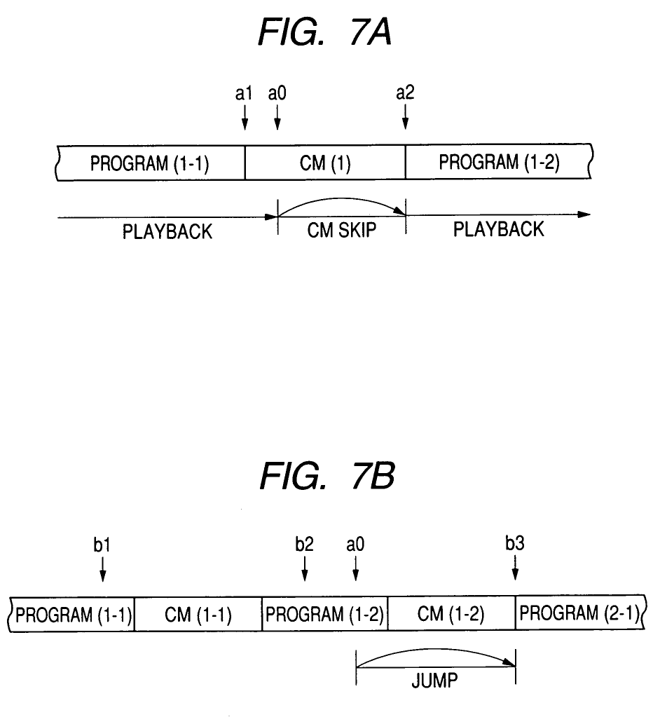

When instructed by the input part 18 to perform CM skip, which is to skip CMs during a playback (Step S11), based on the mode change recording positions recorded in the RAM 14b, the controller 14 searches to see whether there is any recording position corresponding to the mode changes in a 3-minute section, i.e., a normal air time of airing CMs since the current position at which CM skip has been instructed (Step S12, Step S13). When finding as a result of this a recording position corresponding to the mode changes in the 3-minute section (Yes at Step S13), the controller 14 skips CMs up to this recording position corresponding to a mode change (that is, up to the last recording position of the CMs) (Step S14). To be specific, as shown in FIG. 7A, when instructed to perform CM skip during a playback of the recording position (address a0), the controller 14 automatically skips CMs to the address a2 which denotes the immediately following mode change recording position.

On the contrary, when finding no recording position corresponding to the mode changes in the section whose duration is the predetermined period of three minutes (i.e., when the substantial playback time between the address a0 and the address a2 shown in FIG. 7A is over three minutes), determining No at Step S13, the controller 14 performs CM skip for a preset period of time (which may be 30 seconds, for example) set in advance as customarily practiced (Step S15).

<CM Skip 2>

In the event that a CM skip mode for skipping CMs during a playback is set in advance in a setting operation via the input part 18 (Yes at Step S21), the controller 14 makes the mode detector part 21 constantly monitor a mode change of the audio signal (Step S22). Upon a mode change (Yes at Step S22), based on the mode change recording positions recorded in the RAM 14b, the controller 14 searches to see whether there is any recording position corresponding to the mode changes in a 3-minute section, i.e., a normal air time of airing CMs since the recording position at which this change has occurred (Step S23, Step S24). When finding as a result of this a recording position corresponding to a mode change in the 3-minute section (Yes at Step S24), the controller 14 skips CMs up to this recording position corresponding to a mode change (that is, up to the last recording position of the CMs) (Step S25). In this instance, the controller 14 automatically skips CMs from the address a1 which denotes this following mode change recording position shown in FIG. 7A to the address a2 which denotes the immediately following mode change recording position.

On the contrary, when finding no recording position corresponding to a mode change in the section whose duration is the predetermined period of three minutes (No at Step S24), noting a high possibility that this is not a mode change attributable to CMs, the controller 14 continues playing back (Step S26). This makes it possible to skip the CM part while playing back the main program content without fail.

<Time/Picture-Search>

When instructed for time/picture search during a playback, based on the reference time point recording positions recorded in the RAM 14b, the controller 14 searches to see whether there is any mark-off position of every quarter which is a reference time point recording position after the recording position at which time/picture search has been instructed (Step S31, Step S32). When finding as a result of this a quarter mark-off position (Yes at Step S32), the controller 14 skips to the closest reference time point recording position which is the next quarter mark-off position (Step S33) and thereafter continues playing back. To be more specific, as shown in FIG. 7B, when instructed for time/picture search while playing back the recording position (address a0), the controller 14 automatically jumps to the address b3 which is the closest reference time point recording position (quarter mark-off position), whereby time/picture search is performed.

On the contrary, when not finding a next quarter mark-off position (No at Step S32), the controller 14 ends the processing.

What is claimed is:

1. An information record/playback apparatus which digitizes a video signal and a audio signal representing a program comprised of a main program content and a commercial message, records the video signal and the audio signal on a recording medium, and plays back and outputs the video signal and the audio signal thus recorded, the apparatus comprising:
a mode detecting unit which detects a mode change of the audio signal;
a timer unit which measures a present time;
a mode change position storing unit which stores, during a recording operation, a recording position corresponding to the mode change of the audio signal detected by the mode detecting unit;
a reference time point recording position storing unit which stores, during the recording operation, a recording position when the present time measured by the timer unit becomes reference time points set in advance of the 0 minute, 15 minutes, 30 minutes and 45 minutes of every hour; and
a playback control unit which controls a playback of program information recorded on the recording medium,
wherein
the playback control unit, when instructed to perform a commercial-message skip which is to skip the commercial message during a playback, based on the recording position stored in the mode change position storing unit, confirms whether there is any recording position corresponding to the mode changes in a section of a predetermined period, which is a normal air time of airing the commercial messages since the position at which the commercial-message skip has been instructed, and
when finding a recording position corresponding to the mode changes, the playback control unit performs the commercial-message skip up to the recording position,
but when not finding any recording position corresponding to the mode changes in the section of the predetermined period, the playback control unit performs the commercial-message skip for a predetermined period of time set in advance, and
further, when instructed to perform time/picture search during a playback, based on the reference time point recording positions stored in the reference time point recording position storing unit, the playback control unit performs time/picture search of skipping to the closest reference time point recording position to the position at which time/picture search has been instructed and continuing a normal playback operation.

2. An information record/playback apparatus which digitizes a video signal and a audio signal representing a program comprised of a main program content and a commercial message, records the video signal and the audio signal on a recording medium, and plays back and outputs the video signal and the audio signal thus recorded, the apparatus comprising:
a mode detecting unit which detects a mode change of the audio signal;
a mode change position storing unit which stores, during a recording operation, recording positions corresponding to mode changes of the audio signal detected by the mode detecting unit; and
a playback control unit which controls a playback of program information recorded on the recording medium,
wherein the playback control unit, when instructed to perform a commercial-message skip which is to skip the commercial message during a playback, based on the recording positions stored in the mode change position storing unit, confirms whether there is any recording position corresponding to the mode change in a section of a predetermined period, which is a normal air time of airing the commercial message, since the position at which commercial-message skip has been instructed, and
when finding a recording position corresponding to the mode changes, the playback control unit performs the commercial-message skip up to this recording position,
but when not finding any recording position corresponding to the mode change in the section of the predetermined period, the playback control unit performs the commercial-message skip for a certain period of time set in advance.

3. An information record/playback apparatus which digitizes a video signal and a audio signal representing a program comprised of a main program content and a commercial message, records the video signal and the audio signal on a recording medium, and plays back and outputs the video signal and the audio signal thus recorded, the apparatus comprising:
a mode detecting unit which detects a mode change of the audio signal;
a mode change position storing unit which stores, during a recording operation, a recording position corresponding to the mode change of the audio signal detected by the mode detecting unit; and
a playback control unit which controls a playback of program information recorded on the recording medium,
wherein in the event that a commercial-message skip mode for skipping the commercial message during a playback is set in advance, the playback control unit makes the mode detecting unit constantly monitor a mode change of the audio signal, and upon a mode change, based on the recording position stored in the mode change position storing unit, the playback control unit confirms whether there is any recording position corresponding to the mode change in a section of a predetermined period, which is a normal air time of airing the commercial message, since the position at which this change has occurred, and
when finding a recording position corresponding to the mode change, the playback control unit performs a commercial-message skip up to the recording position, but when not finding any recording position corresponding to the mode change in the predetermined period, the playback control unit continues playing back.

4. An information record/playback apparatus which digitizes a video signal and a audio signal representing a program comprised of a main program content and a commercial message, records the video signal and the audio signal on a recording medium, and plays back and outputs the video signal and the audio signal thus recorded, the apparatus comprising:
a timer unit which measures the present time;
a reference time point recording position storing unit which stores, during a recording operation, recording positions as they are when the present time measured by the timer unit becomes reference time points set in advance; and
a playback control unit which controls a playback of program information recorded on the recording medium,
wherein the playback control unit, when instructed to perform time/picture search during a playback, based on the reference time point recording positions stored in the reference time point recording position storing unit, performs time/picture search to the closest reference time point recording position to the position at which time/picture search has been instructed and continuing a normal playback operation.

5. The information record/playback apparatus according to claim 4, wherein the reference time points are the 0 minute, 15 minutes, 30 minutes and 45 minutes of every hour.
